(19) United States
(12) Patent Application Publication
(10) Pub. No.: US 2012/0253937 A1
(43) Pub. Date: Oct. 4, 2012

(54) Real Time Media Selection and Creation of a Composite Multimedia File Used for Custom Advertising and Marketing

(76) Inventors: Donald J. Wing, Thunder Bay (CA); Darryl MacArthur, Thunder Bay (CA); Hal A. Lightwood, Thunder Bay (CA); Donald M. Lukawy, Chene-Bougeries (CH)

(21) Appl. No.: 13/512,596

(22) PCT Filed: Nov. 30, 2010
(86) PCT No.: PCT/CA10/01867

§ 371 Date: May 29, 2012

Related U.S. Application Data
(60) Provisional application No. 61/265,198, filed on Nov. 30, 2009.

(51) Int. Cl. G06Q 30/02

(52) U.S. Cl. 705/14.58; 705/14.4; 705/14.49; 705/14.66; 705/14.71

(57) ABSTRACT

The present invention relates to a method for automatic conversion of an audio file in a first format to an advertising supported media file in a second format. The method includes the steps of: i) receiving a user selection of the audio file for downloading to an electronic device having a screen; ii) selecting from an advertisement database, advertisements that match a profile of the user; and iii) combining the audio file with selected advertisements to create the advertising supported media file in the second format that is suitable for playback on the electronic device on which the media file is to be downloaded. The advertising supported media file is arranged to playback the selected advertisements in parallel with playback of the requested audio file.

### FIELD OF INVENTION

The present invention generally relates to the real-time advertising targeting and creation of a unique multimedia file containing audio, visual advertising and marketing components, and more particularly the present invention relates to incorporation of visual advertising into user selected audio content. The present invention further relates to a system for sending advertising content to a user in association with a text message in response to a user initiated phone call.

### BACKGROUND

Some of the biggest challenges in the music and advertising industries relate to the well publicized problem of pirated digital music distribution and sharing which has dramatically reduced global physical CD music sales over the past few years causing a crisis in the music industry. Sales of digital music products have risen. However, sales are not growing fast enough to arrest the overall decline of the market. Put simply, the most innovative new business models are totally undermined by freely available (i.e. illegally pirated) music.

Services to legally sell copyrighted digital audio with and without digital rights management (hereafter “DRM”) exist, however despite this, many individuals choose to illegally acquire such copyrighted media. This is known as pirated music and results in the loss of revenue for the copyright holders. Existing methods employed to reduce music piracy have failed as demonstrated by continued music piracy. There is a need for a service or method which substantially reduces or eliminates the amount of pirated music consumed and the loss of revenue for copyright holders.

People attempting to obtain copyrighted material illegally often have difficulty locating certain content, and once obtained, some individuals discover such material contains spy ware, malware, adware, viruses, identity theft methods, Trojan downloaders, and pop-up ads which install without permission, having a severe impact on computer performance.

Some services currently exist which provide copyrighted audio content with little or no cost, however these services generally require a subscription fee, the purchase of a specific brand and model of media playing device or only allow the content to be consumed via a streaming method which is often low quality, prone to interruption or which requires the consumer to view additional content, usually advertising, prior to listening to the content they requested. In addition, streaming content is generally cached and does not license it for use when the content is stored on the user system and therefore cannot be consumed without the availability of the service and or network providing it. There is also a time delay in which the consumer must wait for the streamed content before the music can be consumed. Some existing content providers have unsuccessfully attempted to subsidize or partially subsidize the cost of the music by requiring consumers to be exposed to advertisements on a web site or prior to being granted access to the content they requested. In addition to most of these services being restricted to certain devices, most of them are also restricted to certain geographical markets or regions. As the result of these many substantial drawbacks and the lack of a 100% subsidized advertising solution accepted by consumers, music piracy continues unabated.

### SUMMARY

The present invention is referred to herein as the Vringz Method. The Vringz Method described herein provides a service for consumers to obtain copyrighted music without having to directly pay the copyright holders or the services providing the content for the right to licence and use that music content and allow the copyright holders to be compensated fairly by the advertisers that will combine their visual advertising and marketing components with the audio to form a unique video format media file. The advertisers essentially subsidize the entire cost of the music, thus allowing consumers to easily obtain and licence it without cost.

With the Vringz Method, various visual components are combined with an exclusively audio component to create a new media file which introduces a new visual element or component which did not previously exist. The approach of taking digital audio music and adding it to an new “empty” video format file introduces and provides a visual element “space” not typically available in digital audio music files. This visual element can be utilized for advertisements and marketing components having original formats which use in a video file is both unusual and unconventional is both unique, and novel. However, the format of the ad is a series of still images that when displayed in the correct sequence and rate still represent a video sequence. When combined in this manner, the unique media file is much smaller than a typical video file making it feasible for distribution, storage, and user acceptance yet still providing a visual “space” for advertising and numerous marketing components and user generated content (“Hereafter “UGC”). UGC can include the user's own photographs, of which they choose to be added to the media file.

The plurality of visual advertising which in one embodiment appears as flashing animated gifs provides a unique visual presentation appearing in parallel to the audio presentation. In addition to the unique visual advertising components, artist cover art, exclusive artist related content, trivia questions, facts relating to the artist, mobile coupons, accessible Internet links, digital tickets, digital signatures, pin codes, redeemable prizes, contest details, live music event information or the consumers own UGC may also be visibly or invisibly embedded into the media file for marketing, entertainment or tracking purposes. Photographs taken at one or multiple locations such as live entertainment events at which one or more of the marketing components within in an original unique media files was consumed or obtained, can be utilized in the creation of an additional unique media file or files and made available to the original user or additional users. The unique and attractive advertising presentation and the inclusion of the marketing components and UGC will obtain user acceptance and adoption of the media files containing advertisements. The unique viewing experience will attract and maintain the user's attention in viewing the visual advertisements justifying their fees and thus enabling full cost subsidization.

The unique media file provides also provides a means to distribute coupons and vouchers for reductions in the price of products or services for customers, quicker and more dynamically in a much more cost effective and targeted manner.

The unique media file provides a means to distribute tickets purchased for events such as musical performances, in a format that is more cost effective and allows for better tracking, recording, billing and security.

The availability of subsidized cost copyrighted material, will reduce or eliminate the desire and need for individuals to obtain pirated music. Globally, consumers will be provided convenient access to the highest quality, DRM free and virus free audio content, specifically created for whichever video capable device they may own. Unlike with other services, the consumer will license the content for their own use and license them to redistribute to other consumers and consumer devices, provided the media file is not altered (i.e. stripping the music track out and removing the ads. The consumer will not have to spend time searching for copyrighted materials available illegally, risk downloading and utilizing a contaminated file nor risk legal prosecution for doing so.

The Vringz Method also addresses the issue of Pre-Release music Piracy which is a substantial issue in the music industry as copyrighted music makes the bulk of its revenues in the first six weeks after its release. With this method, the unique media file can be made available globally instantly, which eliminates this critical problem.

The approach of the unique media file avoids the need for any digital rights management (“DRM”) by subsidizing the entire “purchase” of music using concurrently provided/displayed advertisements.

Certain products and services are limited in the methods of advertising due to legal restrictions on the age of individuals who may be exposed to advertising for such products. This has resulted in the owners of those products potentially being unable to advertise their products effectively as existing advertising methods may not effectively determine the age of individuals that may be exposed to such advertising. Thus, there is a need for a method of advertising which determines the age of the individual who will see the advertisement. The Vringz Method described herein provides a system by which advertisers of products can determine the age of the individuals to be exposed to that advertising such that only the individuals who are of the legal age will be delivered media containing such advertising.

Further advantages will be become apparent from a study of the following description and the accompanying drawings.

The Vringz Method is a system for combining copyrighted digital audio with paid targeted advertising, marketing components into a unique digital media file to be delivered to digital media devices connected over an electronic network such as the Internet without the user of the media player device having to directly pay the copyright holder for the right to listen to the digital audio. This method provides a means for the copyright holder to be compensated through the advertising revenue paid by advertisers. Ads may be targeted by device type, mobile/cellular operator, geographic location, gender, age or any number of other criteria that can be determined about the user of the device that the media file is to be delivered to, as specified by an advertiser. Advertising placement and fees are determined by a system of bidding or flat rate as specified by the operator of the system. The delivered media may also contain one or more images strategically placed within the media file that represents a unique string of combined numbers, letters or other unique characters or marks that the viewer of the media may see and then use to enter contests or lotteries or other marketing or promotional uses to claim prizes at an associated website or other place where that code can be accepted by an advertiser, business or the operator of the system. In one embodiment, every delivered file is unique and the digital checksum signature with information about every delivered file is logged and stored in a database.

According to one aspect of the present invention there is provided a method of combining advertisements with digital audio content, the method comprising:

receiving a user selection of the audio content;

selecting at least one advertisement from an advertisement database comprising a plurality of advertisements in which each advertisement comprises at least one image; and

creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

Preferably the user selection comprises an audio file which only comprises the audio content.

When the user selection comprises a file with audio content, the method preferably includes creating the media file such that the media file comprises only the audio content from the user selected file.

The media file may be created only after receiving the user selection.

The advertisement is preferably selected according to criteria including a type of the media enabled device, for example a location of a user, age of a user, gender of a user, or the user information.

The location of the user may be determined according to a positioning technology, a unique network identifier, or a user specification.

When the advertisement selected comprises a plurality of images in a video format, the method may include reducing a frame rate of the video format prior to creating the media file comprising said plurality of images in the video format.

The method may further include incorporating unique indicia into at least one image of the media file being created.

When provided with a plurality of promotional codes of a promotion, the method may include incorporating the unique indicia into at least one image of the media file being created such that the unique indicia represents a respective one of the promotional codes of the promotion.

A unique tracking code may also be incorporated into the media file being created.

When each advertisement includes a display duration associated therewith, the method preferably includes selecting a plurality of advertisements such that a combined duration of the display durations is equal to or less than a duration of the user selected audio content.

The advertisement database may be populated with the plurality of advertisements by accepting advertising bids from advertisers in which each advertising bid includes a payment offer for each instance the advertisement is incorporated into a media file. The payment offer may include a maximum total amount of instances the advertisement is to be incorporated into media files.

When creating the media file comprising a plurality of selected advertisements, the plurality of selected advertisements may be ordered according to an amount of the respective payment offers.

Also when populating the advertisement database with the plurality of advertisements by accepting advertising bids from advertisers, each advertising bid may include selection criteria arranged to determine which user selected audio content the advertisement is associated with in creating media files.

When each advertising bid includes a display duration of the advertisement, the method preferably includes selecting a plurality of advertisements such that a combined duration of the display durations is equal to or less than a duration of the user selected audio content.

Preferably the method includes selecting a unique combination of a plurality of advertisements incorporated into the media file according to user criteria, creating a digital checksum signature of the media file using the unique combination, and storing the digital checksum with a media file creation time and date in a database containing the user criteria when the media file is created.

The media file may be created for playback on a media enabled device containing an application in which an embedded a trigger in the media file is arranged to be automatically detected by said application responsive to the media file being played on the media enabled device so that the trigger is further arranged to execute an auxiliary function in said application.

The trigger may be arranged to prompt a user for an interaction with the media enabled device prior to executing the auxiliary function in said application.

The trigger may also be arranged to automatically execute the auxiliary function in said application responsive to the detection of the trigger by said application.

According to a second aspect of the present invention there is provided a method of combining advertisements with audio content suitable for playback on a media enabled device, the method comprising:

receiving a user selection of the audio content;

selecting at least one advertisement from an advertisement database comprising a plurality of advertisements in which each advertisement comprises at least one image; and

incorporating unique indicia into said at least one image of the said at least one advertisement selected;

creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

According to a third aspect of the present invention there is provided a method of combining advertisements with audio content suitable for playback on a media enabled device, the method comprising:

receiving a user selection of the audio content;

populating an advertisement database with a plurality of advertisements in which each advertisement comprises at least one image by accepting advertising bids from advertisers, each advertising bid including a payment offer for each instance the advertisement is incorporated into a media file;

selecting at least one advertisement from the advertisement database; and

creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

According to a fourth aspect of the present invention there is provided a method of combining advertisements with audio content suitable for playback on a media enabled device, the method comprising:

receiving a user selection of the audio content;

selecting a unique combination of a plurality of advertisements according to user criteria from an advertisement database comprising a plurality of advertisements in which each advertisement comprises at least one image;

creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device;

creating a digital checksum signature of the media file using the unique combination, and

storing the digital checksum with a media file creation time and date in a database containing the user criteria when the media file is created.

According to a further aspect of the present invention there is provided a method of presenting advertising content on a mobile phone, the method comprising:

providing a communications server arranged to receive phone calls over the internet from mobile phones communicating through a public switched telephone network;

providing a content database comprising advertising content;

delivering a user initiated phone call from the mobile phone of the user using the public switched telephone network over the internet to the communications server; and

terminating the user initiated phone call and sending a text message to said mobile phone from the communications server in response to receipt of the user initiated phone call by the communications server;

the text message including advertising content from the content database associated therewith so as to be arranged to display said advertising content on said mobile phone.

When used with a mobile phone having internet connectivity, the method may further include: providing the content database with internet links arranged to direct a user to advertising content available through the internet; and associating one of the internet links from the content database with the text message sent to said mobile phone so as to be arranged to display said advertising content available through the internet on said mobile phone.

When the communications server is arranged to receive phone calls directed towards a plurality of different advertising phone numbers and different advertising content is associated with the plurality of different advertising phone numbers, preferably each text message sent to a user in response to a user initiated phone call received by the communications server includes advertising content associated with the advertising phone number towards which the user initiated phone call was directed.

A logging database may be provided to log an identification of each mobile phone from which the communication server receives a user initiated phone call. Each mobile phone is preferably identified by a phone number of the mobile phone.

The method preferably includes logging in association with each identified mobile phone each advertising phone number towards which phone calls are directed by the identified mobile phone.

The logging database preferably also logs each text message sent by the communications server along with an associated identification of the mobile phone to which each text message is sent.

A web based management server is preferably arranged to display content of the logging database over the internet to an advertiser associated with the advertising content of the content database.

The text messages may be sent to the user mobile phones according to advertiser selected criteria in which the advertiser selected criteria is arranged to be adjustable by an advertiser with which the advertising content is associated. For example, the advertiser selected criteria may include a prescribed time delay such that the text message is arranged to be sent upon expiry of the prescribed time delay subsequent to receipt of the user initiated phone call. The advertiser selected criteria may also include a scheduled time such that the text message is arranged to be sent at a time which is prescribed by the scheduled time selected by the advertiser. The advertiser selected criteria may further include wording of the text message such that the wording of the text message can be prescribed by the advertiser.

Preferably the web based management server is arranged so that the advertiser is arranged to login and adjust the advertiser selected criteria over the internet.

The method may further include subsequently sending an auxiliary text message to the identifications of a selected group of mobile phones from which the communications server has previously received a user initiated phone call. In this instance a web based management server may be provided onto which an advertiser associated with the advertising content is arranged to login such that the sending of the auxiliary text message can be triggered in response to an instruction received by the advertiser over the internet through the web based management server.

Preferably the auxiliary text is sent according to criteria selected by the advertiser over the internet through the web based management server. The criteria selected by the advertiser may include the identification of mobile phones on the logging database associated with a specified geographical region, or the identification of mobile phones on the logging database associated with at least one selected advertising phone number.

In further embodiments, the method may also comprise sending an auxiliary text message in which the auxiliary text message comprises a polling prompt arranged to be displayed on the mobile phones. In this instance a vote in response to the polling prompt is communicated from the mobile phone to the logging database and the vote is logged in the logging database in association with the identification of the mobile phone from which the vote was received. The vote may be communicated by a text message through the communications server to the logging database, by a telephone call through the communications server to the logging database, or over the internet to the logging database by an Internet link in the auxiliary text message.

Various embodiments of the invention will now be described in conjunction with the accompanying drawings in which:

### BRIEF DESCRIPTION OF THE DRAWINGS

FIG. 1 illustrates an embodiment the structure of the unique composite media file.

FIG. 2 illustrates an embodiment of a process of an advertiser submitting advertising and bidding for placement in the composite media file.

FIG. 3 illustrates an embodiment of a process of the creation of the unique composite media file and distribution to a user device.

FIG. 4 illustrates an embodiment of the system architecture in which the processes may be performed.

FIG. 5 illustrates an embodiment of a process to provide the unique media file to a user of a device with video player capability.

FIG. 6 is a schematic representation of a process to provide advertising content associated with a text message to be sent to a user in response to a user initiated phone call.

FIG. 7 illustrates a further embodiment of the process to provide unique media files to users of Internet enabled mobile phones.

### DETAILED DESCRIPTION

The invention can be implemented in numerous ways, including as a process, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes either a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques that will reduce or eliminate music piracy and provide a method of delivering targeted advertising are disclosed herein. For example, advertisements (hereafter “ad” or “ads”) are selected based on if the advertiser's criteria for including that ad match the known information about the end user and then those ads are combined with music to provide a unique downloadable video file. The criteria for the ads is set by the advertiser and may include but is not limited to the age, gender, location, type of device and song or plurality of songs the user has selected or any number of other criteria that can be matched with information gathered about the end user that intends to download and use the media. Fees for including the selected ads can be determined by a bidding system or flat rate or any other method the operator of the service may choose to employ. The method of a bidding system will be described in more detail below.

An ad is supplied by an advertiser. The advertiser provides ads in a format which is compatible with the format of the media file for each type of device they wish the ad to appear on. The content of the ads is determined by the advertiser and may represent any product or service so long as those products or services to do violate any law by being distributed by these techniques. An Advertiser may provide ads that have been provided to them by any other entity and they have agreed to find methods of delivering that advertising and have been authorized to arrange for the deliver of those ads by these techniques.

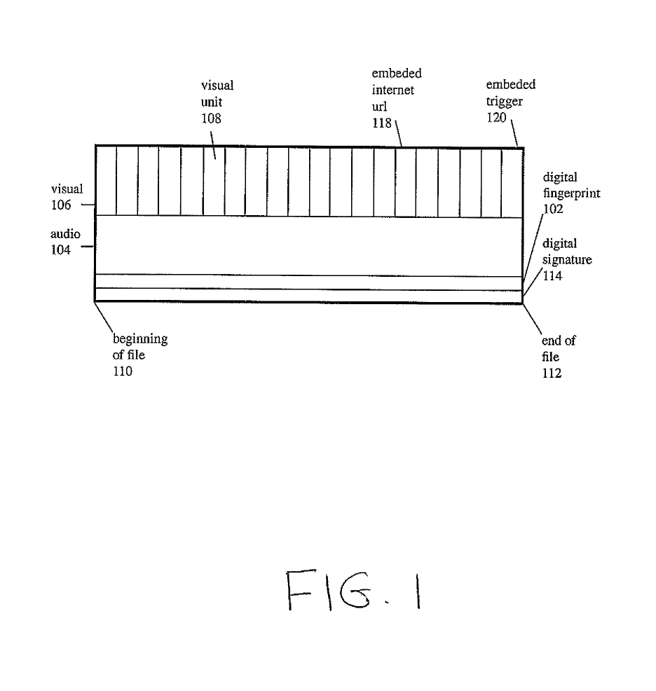

FIG. 1 illustrates an embodiment the structure of the unique composite media file.

The media file 100 is in a format that is compatible with the video media player for a particular user system 402 such as a mobile telephone. The visual component 106 of the media file consists of a plurality of visual units 108 of varied lengths which are displayed on the screen of the user system when the file is played. The visual units can consist of digital image files in a variety of formats including but not limited to animated gifs. The digital images are displayed on the user system as static images and or static images with certain parts or sections of the static image flashing and blinking simultaneously or individually. The Visual units containing static images with certain parts or sections of the static image flashing and blinking will consist of the commercial advertising. The format of the ad is a series of still images that when displayed in the correct sequence and rate represent a video sequence. The rate that the images are displayed is the frame rate and is specified in frames per second (fps). The operator of the service may specify the required frame rate for ads. A lower frame rate will result in a smaller media file that will take less space on the users' device and on the operator server. Smaller media files also will take less bandwidth to deliver which may equate to cost savings for the operator of the service and the user. This technique described is a method of producing a media file that is optimal and efficient for download and storage.

The remaining visual units can contain but not limited to static images consisting of musical artist photographs, artwork, digital mobile coupons, digital mobile tickets, pin codes, contest details, redeemable prizes, event information and user, operator or third party generated visual content such as photographs. The orientation of the images, the resolution and number of colours to be displayed is to match the preferred orientation of the image to be displayed, the resolution and number of colours capable of being displayed on the devices that are intended to be delivered to.

Trivia questions and or facts relating to the artist or an artist of a similar music genre can be displayed as text on the user system screen in combination with or without a static image.

The audio component 104 contains digital audio music.

The visual component is displayed in parallel to the audio component with both components starting at the beginning of the media file 110. and finishing at the end of the media file 112.

The media file contains a unique digital signature 102 and a unique digital fingerprint 114.

In alternative embodiments, the media file contain an embedded Internet URL (Hyperlink) 118. This visual or non visual Internet URL's (Hyperlinks) can initiate a communication link to a web page with a locally installed browser or initiates a software download to the user system. This occurs when the user of the user system performs an action such as touching the screen or a certain part of the screen during the display of a specific visual unit and/or during the display of any visual unit.

In alternative embodiments, the media file contain an embedded Trigger 120. This trigger is non visual can launch a locally installed application such as a text message sending, social networking (Facebook) and/or VOIP (voice over IP) application. Additionally, the trigger may initiate a communication with one of these applications such as the VOIP application initiating a VOIP communication link. The trigger can be activated when the user of the user system performs an action such as touching the screen or a certain part of the screen during the display of a specific visual unit and/or during the display of any visual unit.

In an alternative embodiment, the media file containing an embedded trigger is played within an application which automatically detects and activates the trigger. The application may also detect and activate the trigger when the user of the user system performs an action such as touching the screen during the display of a specific visual unit and/or during the display of any visual unit. The application may also activate the trigger at a later time or date in conjunction with or without an additional user action such as the utilization of a digital coupon or ticket within the media file or media file application.

In an alternative embodiment, an application on the user system which is independent from the media file and/or media player application, automatically detects and activates the media file embedded trigger independently or when the user of the user system performs an action such as touching the screen during the display of a specific visual unit and/or during the display of any visual unit. The application may also activate the trigger at a later time or date in conjunction with or without an additional user action such as the utilization of a digital coupon or ticket within the media file or media file application.

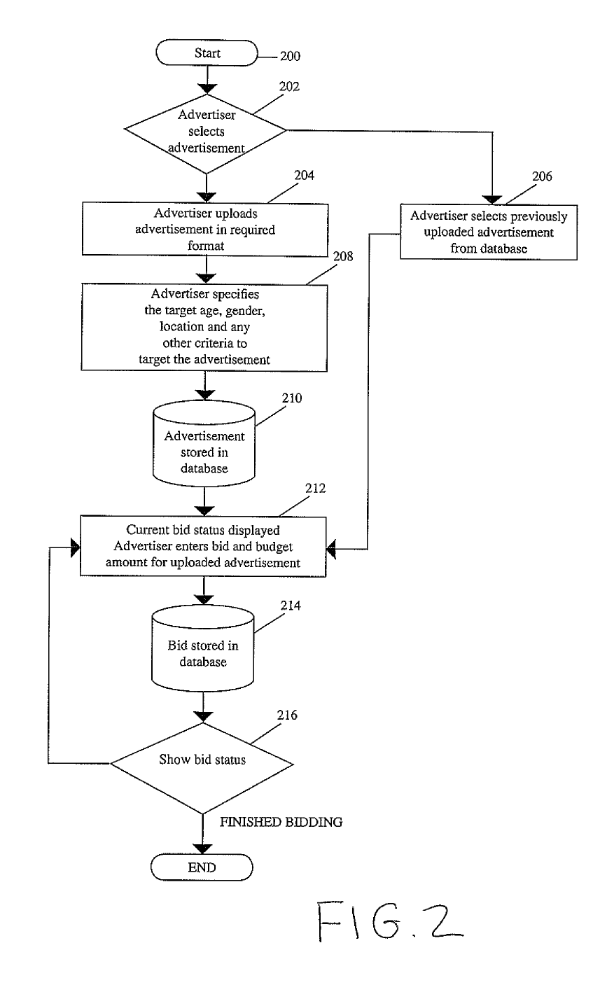

FIG. 2 illustrates an embodiment of a process of an advertiser submitting advertising and bidding for placement in the composite media file.

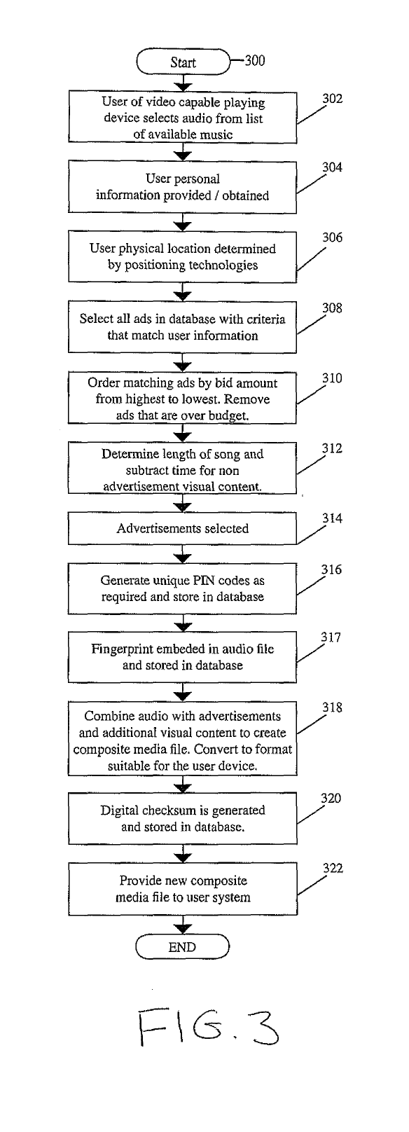

With respect to FIG. 2, for example, process 200 may be employed at an operator website server 410 or media server 412 or both. Process 200 starts at 202 at which an advertiser selects an advertisement (hereafter “ad”) and uploads it in the required format 204 or selects an ad previously submitted to the advertisement database 210. The advertiser specifies the ad targeting criteria such as age, gender and location for which it should be selected to be delivered 208 and allows the advertiser to specify how much they would like to pay per a defined unit a measure (such as per impression) and the total expenditure for an ad before that ad is no longer included in the list of ads to be selected 212. At 214, the bid is stored in the bid database 452. The advertiser may also view their bids against the bids of other advertisers at any time 216. The results of this system are stored in the Bid database for other processes to use as part of the actual delivery technique FIG. 3.

FIG. 3 illustrates an embodiment of a process of the creation of the unique composite media file and distribution to a user device.

With respect to FIG. 3, process 300 starts with a user of a video playing capable device 402, 440 selecting music from a list of music located locally on the user system, or the Operator's Website Server 410. User specific information is provided by the user of the user system 304 on either a one-time basis or by registering for an account which stores this information in the operator's user database 424. User information can be retrieved automatically from the user system, for example retrieved from a local application or from one or more user information database sources 414, 430, 434,436, that may or may not necessarily be associated with the operator of the system. The information about the user includes, but is not limited to, age, gender, type of device or model of the device they intend to play the media file and any other information that may be useful in determining which advertising might be most suitable for them. In addition to obtaining the geographical location of the user system from the user or a user information database source, it can be automatically determined by one or more positioning technologies 306 such as IP address, IMEI, Operator Cell-ID, GPS, A-GPS, WIFI, or manual user input.

Process 300 then compares the criteria for ads that have been stored in the advertisement database by process 200 illustrated in FIG. 2 with the user information. On a per ad basis, if the criteria match as specified by the advertiser then that ad is included in a list of potential ads to be included in the unique media file FIG. 1. All ads in the advertisement database 418 are compared and once this is complete the matching ads are ordered by bid amount from highest to lowest 310. The ads will be checked to determine if any have reached the maximum budget expenditure for each ad amount as specified by the advertiser that submitted that ad and the ad will be removed from the list if its maximum expenditure has been reached or exceeded. The time duration of the song that the user selected will be determined and an appropriate amount of time will be subtracted from that duration to include other non ad content (digital coupons, digital tickets, contest details, prizes, PIN codes, album art, UGC, (or any other visual content) that the operator of the service has specified to be included 312. The resultant length will be used to determine which ads from the list of potential ads will be included by selecting the ad from the top of the list and descending from the bottom until the maximum amount of time has been reached 314. The selected ads now form the final list of ads that will be included in this particular unique media file.

Process 300 then inserts at strategically advantageous points, items that represent images of a unique generated PIN code that the user may use to enter contests or other promotional uses as can be specified by the operator of the service, into the list of ads 316. The pin code is then stored in the Pin Code Database 444. The strategic point where these images are inserted into the media file, is at the discretion of the operator of the service and may employ randomness or pseudo randomness or some formula that the operator feels is advantageous in determining the best placement.

A digital fingerprint 317 is embedded into the music audio file obtained from the music database 420 and the fingerprint stored in the fingerprint database 450.

The ads and the visual content 318 to be included in the media file which are located in the advertisement database and visual content database 422 are then combined with the actual digital music audio file to create the composite media file FIG. 1 converted in the format that is best suited for the user system.

A digital checksum of the file 320 is calculated (using the MD5 algorithm or other established method) and the checksum is stored in the checksum database 454.

The new unique media file 322 will be provided to the user system over one or more computer networks such as but not limited to a Telecommunications network 404, the Internet 408 or a combination of both.

Depending on the speed of the computer system employing this method, the time required to create the media file will vary. In alternative embodiments, the operator may choose to have the user wait while the media file is created or optionally indicate to the user that they will be notified when the media is ready for them to download by email, text message or any other automated electronic method of communication. The communication may include an Internet URL which the user may utilize from their personal computer or mobile device that would allow the media file to be downloaded directly to that device.

In alternative embodiments, the operator of the service's website server may host an independent, fully featured UGC sharing social networking site, containing user profiles and user content such as photographs and the unique media files. An application created and designed specifically for this website and online community can be distributed and installed on user systems, which is used to request, distribute, manage and/or play the media files. The application can also be used by the user to select the UGC such as the user's photographs, to be included in new unique media files.

In alternative embodiments, UGC selected by the user to be added to a new media file, can be obtained from a single or plurality of sources. For example, from the user system itself or a locally installed application on the user system, a user can select the content locally on the user system or from a remote source such as a UGC Provider (community sharing website such as Facebook) 426, UGC Providers 442 not associated with locally installed applications, the Operator's User Content Database 446, additional user system(s) 440 or user devices with storage space 456.

In alternative embodiments, the operator's media server can automatically distribute new and/or updated media files or an updated list or visual display of available music audio to a user system. This can be scheduled for a specific date or time, as the result of certain configurations or conditions specified by the user system, an application on the user system or the operator's media server. This can also be initiated manually by the user of the system, or the operator of the media server.

In alternative embodiments, an application on the user system or the user system itself can be configured to distribute media files to other user systems or to a UGC Provider (community sharing website such as Facebook), UGC Providers not associated with locally installed applications, the Operator's User Content Database, additional user system(s) or user devices with storage space.

In alternative embodiments, the operator of the system may be the ISP (Internet Service Provider) 436, Mobile telecommunications provider 430, Advertisement Provider 428, UGC provider 426, 442, Text Message Aggregator 406 or other third party operator.

The techniques and methods described may be implemented as a process on an electronic device such as a server, personal computer or personal mobile device. The descriptions and figures represent an implementation of the methods on a web based Internet service where a user visits a website and downloads a file to their personal device, however there is no intended restriction on what type of device any of the processes that utilize these techniques can be. For example, the process of selecting music and combining it with advertising could occur entirely on a personal computer owned by the end user and linked to the Internet such that the advertising and music could be delivered directly to an application running on that personal computer. The process could also reside entirely on a mobile device such as a mobile phone with media playing capabilities that is connected to the Internet over a wireless link. The source of music is also not restricted and is simply defined as a database of digital audio files in a format such as, but limited to MP3. The database may be, in the case of a web based service, hosted on the operator of the services Internet servers. In the case of the process residing on a users own personal computer, there is no restriction, for example, on that process utilizing a local database of digital audio files on that same personal computer. In the case of the process residing on a users own personal computer, there also may be no restriction on the end user specifying a certain amount of other custom content they may wish to include as images combined with digital audio (user owned digital photographs for example).

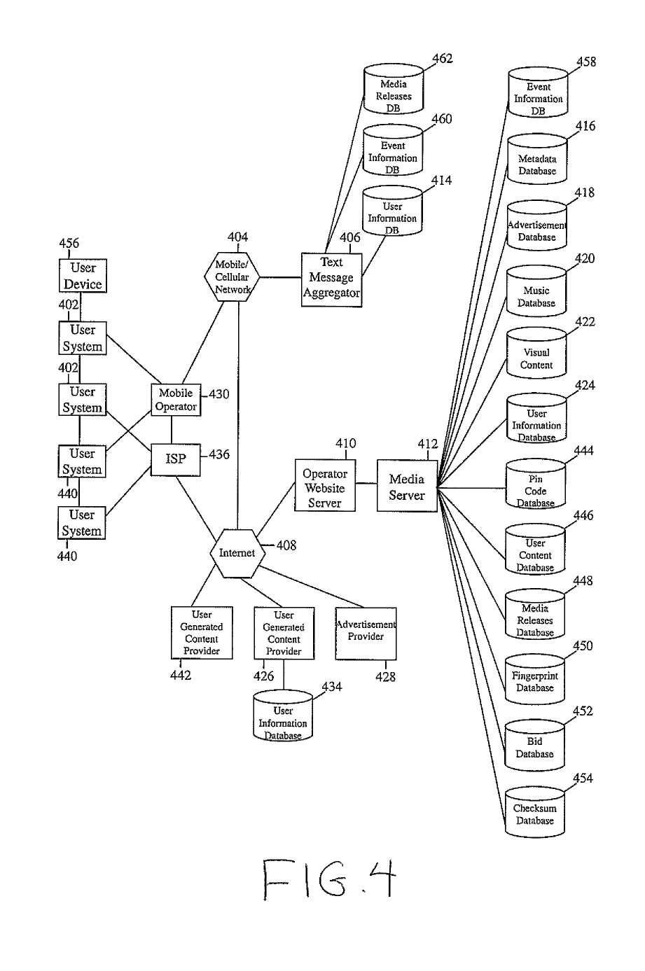

FIG. 4 illustrates an embodiment of the system architecture in which the processes may be performed.

This system allows a user of a user system 402, 440 such as a mobile telephone or computer to obtain music audio content available from the Operator of the service, for example from the Operator's Website Server 410 and Media Server 412. The operator's service can be accessed via a network such as the Internet 408 through an Internet Service Provider (ISP) 436 or via a mobile/cellular network 404 through a mobile/cellular operator 430. The Advertisement provider or Advertiser 428 provides advertising content via the internet to the Operator of the system to be stored in its Advertisement Database 418. To create the composite media file The Media Server uses the ads stored in the Advertisement Database, and content stored in the Music Database 420, Visual Content Database 422, User Information Database 424 and/or UGC Database 446, of which can be stored locally on the media server or through a distributed network environment. The media server utilizes data in fingerprint database 450, checksum database 454 and metadata database 416 in the creation of the media file. UGC to be included in the media file can also be obtained from the User System requesting the media file and/or from one or more UGC Providers 426, 442 via the Internet. UGC can also be obtained from additional User Systems 440, or User Devices such as a device with hard disk storage 456 via a local or network connection or technology such as Bluetooth.

This system enables the user of a user system, specifically a mobile/cellular telephone to initiate phone calls and send and receive text messages with a text message aggregator 406. This communication occurs via a mobile/cellular network 404 through a to a mobile/cellular network operator. Personal user information provided from the user themself, the user device, and the mobile operator is sent to and stored in the Text Message Aggregator's user information database 414 via the mobile cellular network. Data transfer and/or database synchronization between the Text Message Aggregator's and Operator's user information databases and event information databases 460, 458 and media releases databases 462, 448 occurs via a mobile cellular network, the internet or a combination of both.

Information added in the text messages distributed to the user from the text message aggregator, is obtained from the text message aggregator's event information database and media releases database.

On the user system, communication initiated from a media file embedded Internet URL or trigger (launching an application such as a VOIP application for example), is transmitted to the Operator's website server on the internet via an ISP, mobile/cellular operator or a combination of both.

On the user system, communication initiated from a media file embedded trigger which sends a text message or launches an application which sends a text message for example, is transmitted to the mobile/cellular network or to the internet via an mobile/cellular operator and ISP.

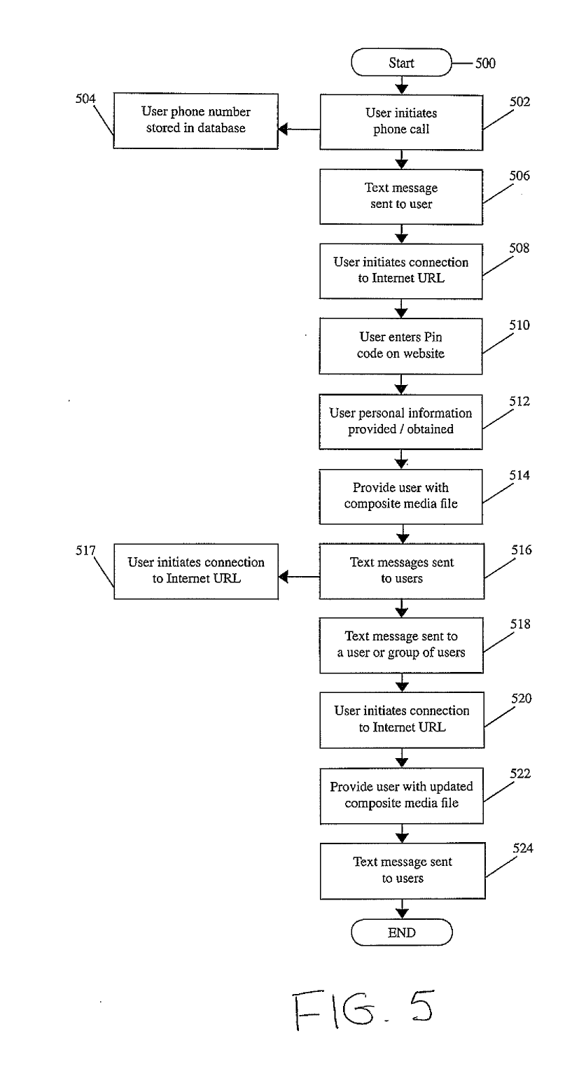

FIG. 5 illustrates an embodiment of a process to provide the unique media file to a user of a device with video playing capability.

With respect to FIG. 5, process 500 is employed by a user of a mobile/cellular telephone 402, initiating a phone call 502 to a phone number managed by a Text Message Aggregator 406. The user's phone number 504 is stored in the Text Message Aggregator's User Information Database 414.

The Text Message Aggregator 506 will then send a text message to the user of a mobile/cellular telephone which contains an Internet URL (Hyperlink) to a webpage on the Operator's Website server 410. The user can access the Internet URL 508 on the device which received the URL or with a separate user system 440. On the website 510, a user enters a UPC code or PIN code (originally sourced from the Pin Code Database 444) which was provided to the user when purchasing a product or obtaining a sample of a product. 512 The user will be requested to enter personal information such as geographic location, gender, age or any number of other criteria which will be stored in the Operator's User Information Database 424. The user will then be provided with a composite media file 514 or files according to FIG. 1 for download to the user system.

The media files provided are related in some aspect to the product purchased or sample product received by the user. For example, if the product purchased is a concert ticket of a musical artist, the unique media file or files will contain audio music of that specific artist or an artist within the same or similar music genre. This media file or files may contain exclusive content such as audio music or photos of the artist, not released to the consumers via any other distribution channel or method. Exclusive content can also include the physical (paper) event ticket purchased in digital format which can be also be used for entrance at event venue. It may also include exclusive digital vouchers or coupons which can be redeemed at the concert venue, in retail outlets, on the internet through a browser or through an application stored locally on the user system. It may also include and additional pin code from the Pin Code Database which allows them access to a website or membership in an exclusive Social Networking Community Group and to all information and content available on the website and to the group.

In advance of the event taking place for which the user has purchased or obtained a ticket, the text message aggregator distributes text messages 516 to users which contain event information and/or Internet URL's 517. The user selects the Internet URL on mobile/cellular telephone which received the Internet URL or on a separate user system and initiates a connection to a website on the operator's website server. The information which may be presented in the text message itself or on the website of the internet URL, may contain but is not limited to hotel, restaurant, bar, and club information located near the event venue. Weather conditions, traffic information on routes leading to the venue, parking locations and space availability in each, along with tips and safety information may be provided. This website which may be ad supported may also include a chat section for event ticket holders to communicate.

At the time of the event, the Text Message Aggregator sends a text message to the telephone number of a user which is stored in the Text Message Aggregator's User Information Database, informing the user that they have won a prize. For example, the user which purchased a concert ticket would be sent a text message during the event, informing them that they have won a prize such as a car, a music CD, a T-shirt or backstage passes to meet the artist.

Following the event, the Text Message Aggregator sends a text message 518 to a user or group of users, which contains an Internet URL (Hyperlink) to a webpage on the Operator's Website server, a musical artist's Internet website and/or a UGC Provider website (for example Youtube.com) 442. The user can access the Internet URL website 520 on the device which received the URL or with a separate user system. This website provides updated or modified versions 522 of the original media files that were provided to the same user as in 514. These updated or modified files contain additional visual content such as photographs taken at a concert or event, for which the user originally purchased a ticket, will be available for downloading or viewing.

Additionally, the text Message Aggregator sends a text message 524 to the telephone numbers of select users, who's telephone numbers are stored in its User Information Database. The Text message may contain related upcoming event Information in the user's geographical area (obtained from the Event Information Database 460), media releases of the artist (obtained from the media releases database 462). The text message may also contain an Internet URL (Hyperlink) to a webpage on the Operator's Website server and/or UGC Provider website 442 (you tube). This website provides media files containing newly released music audio from the artist associated with the user profile or from an artist within the same or similar music genre.

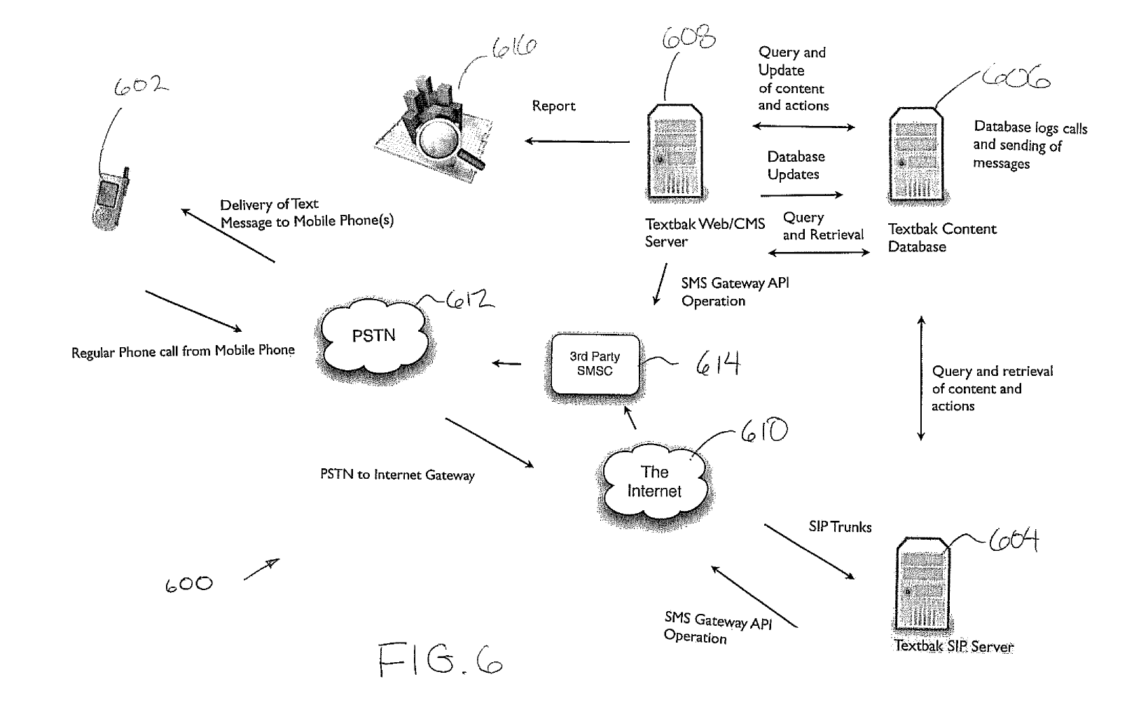

Turning now to FIG. 6, there is illustrated an advertising method and system generally indicated by reference numeral 600. The system 600 is particularly suited for use with a mobile phone 602 such as a Smart Phone having internet connectivity and a suitable display screen.

The system 600 generally comprises a communications server 604 in the form of an IP session initiated protocol server which controls the receipt of phone calls and the sending of text messages for the system. The system 600 is generally referred to herein as the Textbak system and method while the communications server is generally referred to as the Textbak SIP server. The communications server 604 is in communication with a Textbak database 606 in which one component comprises a content database that stores the content and actions to be taken for different designated phone numbers of the system. Another component of the Textbak database 606 is a logging database arranged to log various activities of the systems including phone numbers and other identification of mobile phones with which the system is in communication.

A further component of the system is a web-based content management system in the form of a web-based management server 608. This server is the control interface for the operator of the Textbak method. This server can also be used as an interface for sending text messages as required. The management server 608 is in communication with the Textbak database for updating the database as well as querying and retrieval of information between advertisers interacting with the system at the management server and the contents of the Textbak database 606.

The system 600 communicates with mobile phones by arranging the communications server 604 to communicate with the internet using an SMS gateway API operation when sending text messages over the internet while receiving SIP trunks from the internet when receiving phone calls. The phone calls are delivered over the internet 610 from a public switched telephone network 612 using a PSTN to internet gateway provided by a suitable telecommunications provider. Phone calls from mobile phones 602 of users can then be placed in a regular manner from the mobile phone through the public switched telephone network 612 to be communicated over the internet gateway to the internet 610 and subsequently by the SIP trunks to the communications server 604 which resides in a data centre.

Upon receiving the call, an identification of the mobile phone which placed the phone call is recorded and logged onto the database 606. The system includes a plurality of different advertising phone numbers associated therewith to which phone calls from different user mobile phones 602 are directed. The server 604 queries the database 606 based on the specific phone number to which the phone call from the user is directed so as to retrieve the appropriate content and actions to be taken from the database.

The database includes different advertising content associated with the different advertising phone numbers, typically in the form of an internet link arranged to direct the browser of a mobile phone to the Internet content which is subsequently delivered to the user by the Internet connection of the mobile phone. The content delivered to the mobile phone may be in the form of a composite media file of user selected audio content with visual advertising images attached therewith as described above with regard to the previous embodiments.

A typical action for the communications server 604 involves sending an SMS text message over the internet using a third party SMS gateway server 614 such that the text message is delivered back through the public switched telephone network 612 to the mobile phone which placed the initial phone call to the system.

Various criteria relating to the sending of the text message and the content thereof can be prescribed by an advertiser associated with the advertising content to be sent to the user.

One of the criteria may be a time delay such that the text message is not sent to the user until expiry of a prescribed time delay from the time of receipt of the phone call from the user. Alternatively, the text message may be sent at a scheduled time independent of the receipt of the time of the phone call from the user. In yet further arrangements, the text message can be sent only upon a subsequent manual trigger by the advertiser. The advertiser can also select one advertising component among several advertising components to be attached as advertising content to the text message. Furthermore, the message sent in the text message together with the advertising content may also be varied and prescribed by the advertiser according to preference.

The content of every message sent by the communication server is also logged with the database 606 in association with the identification of the mobile phone 602 to which the message and sent. All of the details with regard to the phone calls received and the text messages sent can be organized according to various criteria including the identification of phones from which phone calls to the different advertising phone numbers are received, the date or time of receipt or sending of messages, an area code of the numbers, or a specific advertising phone number which is called.

The outgoing text messages can also be classified by date and time, area code or delivery status for example. At any time, an advertiser may log into the system through a web-based interface provided by the management server 608 so that the advertiser can query relevant information associated with that advertiser which resides on the database 606. The management server thus allows various reports of the content on the database to be organized according to any of the criteria noted above for subsequent display to the advertiser through the web-based interface provided by the server 608. The reports 616 can then be displayed or printed or otherwise stored by the advertiser which receives the information through the web-based interface.

Due to the content stored on the database 606, an operator or advertiser of the Textbak system can later initiate additional sending of text messages to any number of designated mobile phones which have placed phone calls to advertising numbers of the system. The subsequent sending of text messages can be triggered manually or according to other criteria at any future time. In this instance, the management server typically gathers appropriate content from the database 606 to define a new action to be taken. The advertiser then specifies the new action through the management server 608 using the web-based interface so that the management server itself can initiate the sending of text messages over the Internet using an SMS gateway API operation similar to the communications server 604 to communicate with the internet 610 and a third party SMSC for subsequent delivery of the text messages to the mobile phones communicating with a public switched telephone network.

In its broadest form, the system 600 according to FIG. 6 is arranged to present advertising content on a mobile phone of a user by first providing a communications server 604 which is arranged to receive phone calls over the internet from mobile phones communicating through a public switched telephone network. The communication server communicates with the content database which includes internet links having advertising content associated therewith. When a user initiated phone call is delivered from a user's mobile phone to the communications server 604, the communication server immediately terminates the user initiated phone call and then sends the appropriate text message associated with the advertising phone number called. Alternatively, the communications server may play an audio message to the user prior to disconnecting the user initiated phone call.

The text message is sent according to the criteria prescribed by the advertiser using the management server 608 so that once the text message is delivered in response receipt of the user initiated phone call, the user of the mobile phone can follow the internet link which directs the user to download the appropriate advertising content from the database 606 or from a separate server communicating the advertising content therefrom over the internet such that the advertising content can be displayed on the display of the mobile phone 602 of the user. The advertising content associated with the internet link corresponds to the respective one of the different advertising phone numbers with which the system 600 is associated. The logging database component of the database 606 logs the identification of each mobile phone from which the communications server receives a user initiated phone call. This identification is preferably the phone number of the mobile phone; however, it may be possible to use other forms of identification, for example a carrier short code. When a user of a mobile phone 602 places phone calls to several of the different advertising phone numbers associated with the system, each of the different phone numbers that calls were directed to by the mobile phone are associated with the identification of that phone to effectively generate a profile of interests or preferences of the user of that phone identification. This information can then be used to target subsequent advertising content delivered to the user.

As described herein, the system 600 involves a client\consumer being provided with a phone number. The client or consumer calls the phone number from a mobile phone and receives a text message or SMS message back to their phone. The text message can contain written text, a URL (web address) or a combination of both. In some situations a client\consumer can be asked to text a Carrier Short Code (CSC) such as 74992 with a specific word, for example “PIZZA”.

A real world example of how Textbak can be utilized is for a company such as a franchise food chain. Various promotional ad campaigns can be run to sell additional product and enable the collection of customer telephone numbers and information. For example in a promotion involving a win/loss prize indicating area on disposable cups or tokens available with a beverage or food purchase, a telephone number replaces the “sorry please try again” on the product, which allows the customer to call to win a Mega grand prize. Phone numbers can be provided by various means without product purchases. When the number is called, it is disconnected, immediately or subsequent to an audio message for example, and a text message is sent to the user which may contain text and/or one or more URLs to a composite media file of FIG. 1 for example. The customer's phone number is then added to a database. The phone numbers provided to the customers\client can be different depending on the type of product purchased, the city, province, country etc. The numbers are then stored in databases and can be used to distribute texts messages to customers in the future based on various factors. The text messages can initiate all of the technical actions mentioned above regarding the composite media file of FIG. 1.

Here are a few basic example text messages:

1) Have you tried our all-new Breakfast Wraps yet? On Special for 99 cents! http://sample.com

2) Nutritional Info available online at http://sample.com/nutrition.pdf

3) Thanks for supporting XYZ Minor League Sports! You will now receive info on XYZ Sporting events.

4) A new food chain XYZ outlet opening soon! Watch for special grand opening announcements coming to your phone!

5) Temperature Alert: when it gets over a certain temp (in a particular region for example) a text is sent which reads “what a great day for BRAND XYZ ice cream”

6) A contest can be setup in which a customer receives a text message which reads “Thanks for playing the XYZ food chain Poker Game. Good Luck! AH KH QH JH 10H-vcj67932ed. A URL is also in the text message which when selected, launches a Vringz file in according with the file of FIG. 1, which can appear for example as the 5 rows on a Slot Machine spinning eventually to a stop presenting the customer with a possible winning combination. The code which appears above “AH KH QH JH 10H-vcj67932ed” is present to verify the phone number is legit

7) Additionally, customers can also collect points from one or more retailer purchase or product vendors. These points can be used for free products or services or discounts. A texting method with codes would be used and individual point collection additions and customer spends added and subtracted to a database. Point accumulation status updates and special offers can distributed to customers by text.

8) Surveys\Feedback—Textbak can also be used obtain feedback from clients\customers by similar methods. For example at a professional sports game, fans are provided with specific phone numbers for certain players to nominate them for player of the game. This can also be setup for various types of sports leagues at various levels with weekly statistics and information announcements being distributed by text messages.

For examples 1 through 4, the client is able to login to the Textbak client administration website and add phone numbers, configure the various parameters for each and add/edit/remove the content of the text message.

In other embodiments, the content of the text message sent by the system 600 to the mobile phone in response to the user initiated phone call further includes a link or connection instruction which directs the mobile phone to stream information over a suitable network. Information which can be streamed to the mobile phone can include an audio track or a video, or any form of multimedia file arranged to be played on the mobile phone of the user. The user may be prompted to connect the mobile phone to the network prior to streaming information to the mobile phone or the streaming may occur automatically.

In further embodiments, the content of the text message sent to the mobile phone includes a trigger that is recognizable to an application on the phone and which is arranged to launch the application automatically. The application can then automatically initiate a streaming session or downloading of various types of multimedia information for example.

In further embodiments, the content of the text message sent to the mobile phone includes one or more user initiated triggers displayed on the phone as a prompt so that an action is performed by the mobile phone when the user selects, activates, or otherwise interacts with one of the triggers. In one example, the trigger displayed relates to a phone number such that the mobile phone is arranged to automatically initiate a phone call to the phone number associated with the trigger.

The system 600 may alternatively be used in helping a company manage its internal operations in the areas of recruitment, staff scheduling, and information updates for employees. One example is individual private work schedules being distributed to employees automatically via the Textbak system. A second examples involves an employee texting the word “ill” or calling a number certain number when unable to work. The Textbak system would automatically send a text message to all on duty managers notifying them and sending a message to all staff that is not on duty and available (not on holidays, off ill themselves, unable to work do to employee laws (maximum hours worked in a day etc)). Employees willing to work the open shift can text or call back the Textbak number and will then receive confirmation that their offer to work has been accepted. Other employees that volunteered will be notified that another employees has already been confirmed accepted. Optionally, all volunteer requests can be sent to the on duty manager for that shift at which time the on duty manager can make the selection from the list of volunteers. A text message can also be sent to HR with full details for their records to be updated.

A benefit of logging the various mobile phone identifications of prior callers to the system 600 has the advantage of collecting a large number of mobile phone identifications over time from various different advertisers' promotional campaigns such that the database of mobile phone identifications can be subsequently used for sending auxiliary text messages to a selected group of the mobile phones from which the communications server has previously received a user initiated phone call. The auxiliary text message can be in the form of an announcement, further advertising/promotional content, collection of feedback from mobile phone users in the form of polls and the like, or various forms of links to various internet addresses to which the mobile phones can be directed.

Sending of auxiliary text messages can be directed in response to an instruction received by an advertiser which logs on to the web based management server for communicating the instruction over the internet. The auxiliary text message can be sent by the advertiser according to various criteria. First, the person logging into the web-based management server retrieves a selected group of mobile phone identifications from the database 606 according to a first set of specified criteria. This may comprise mobile phones associated with a specified geographical region or mobile phones which are associated with a specific advertising phone number which the mobile phones had previously placed a phone call to for example. Once the appropriate list of mobile phone identifications has been retrieved from the content database 606, the web based management server 608 receives further specified criteria from the advertiser which details the wording of the text message and advertising content to be associated therewith as well as the time and date that the text messages are to be sent.

In the example of the auxiliary text message comprising a polling prompt, the prompt is displayed on the mobile phones of the users when accessing the text message such that the user is prompted to communicate a vote back to the system 600. The vote may be communicated back to the logging database of the system so that the vote can be logged in association with the identification of the mobile phone from which the vote was received to further enhance the profile of the mobile phone identification in the logging database. The prompt may be in the form of various phone numbers so that the selection of one phone number to be called versus another by the user effects communication of their vote to the system 600. Alternatively the votes may be communicated by text message back through the communications server 604 for example. In yet further arrangements, the polling prompt comprises one or more internet links directing the user to internet sites to place their vote. In either instance a further action is taken by the system 600 in response to the tally of votes received from numerous mobile phone user.

In one example of the use of an auxiliary text message, users of mobile phone are initially provided with a telephone number prompting the user to purchase a product such as a concert ticket for example. Upon the user phoning the advertising phone number provided by the system 600, the mobile phone user is provided with a text message including promotional content instructing the user how to complete a purchasing transaction of a concert ticket either by replying to the text message or by being directed to an internet link where a transaction can be accomplished over the internet through a web-based interface. The transaction may involve purchase of a digital event ticket that is automatically delivered to the mobile phone user via the text message sent by the communications server. The user may also receive the digital event ticket via text message in response to a text message reply from the user or in response an interaction with the user thru the web-based interface. As described above, the identification of the mobile phone is stored on the database 606 in association with the advertising phone number to which the mobile phone placed a call such that the identification of the phone is associated with a specific event relating to that advertising phone number.

When a further concert or other related event is subsequently scheduled, the mobile phone user can be provided with the auxiliary text message which notifies the user of the subsequent event. Alternatively, the auxiliary text message may be a polling prompt requesting a vote from the identified mobile phone to select a preferred artist to be hosted at a concert or other options relating to an event for example. Subsequent to the tally of the votes, the subsequent event proceeds in accordance with the preferences most voted for by the mobile phone users. Alternatively, the auxiliary text message may be sent at a date subsequent to the initial ticket purchase but closer to the actual event date in which the auxiliary text message provides advertising content relating to associated products such as event merchandise, event parking, or promotion of food venues in proximity to the event location for example.

In a further example, the advertising phone number provided to users is associated with a real estate sign or advertisement relating to the sale of a specific property. When applied to real estate, each advertising phone number of the system 600 is associated with its own respective property such that upon phoning the number, the mobile phone user is provided with advertising content relating to the property for sale. In a preferred arrangement an internet link is sent by text message to the mobile phone user which then directs the phone to an internet site where additional media content is downloaded such as a video profile of the property and various statistical data relating to the property.

In a further embodiment, the phone numbers may be provided to users in association with a lottery voucher attached to a product being sold in which the voucher may be in the form of a numbered lottery ticket or bingo card for example. When the mobile phone user places a phone call to the advertising phone number provided with the lottery voucher, a text message is sent to the mobile phone which prompts the user for a pin code provided on the voucher so that the system 600 can provide an indication to the user whether the voucher is a winning or losing voucher. When using a bingo card, the content of the text message sent to the user may comprise bingo numbers which the user uses to determine if the voucher is a winning voucher. Users in this instance are motivated to purchase more product to receive more vouchers to place more phone calls to the system 600. Placement of each phone call to the system permits the identification of the mobile phone to be logged into the database 606 to permit subsequent text messages in the form of targeted advertising to be later sent to the mobile phone users in the form of auxiliary text messages as described above.

In a further example a lottery is managed by the system in which each phone call placed by each mobile phone comprises an entry into the lottery and a winning amount of the lottery is proportional to the number of entries logged by the system onto the database 606.

In a related application, the advertising phone number of the system may be provided to a plurality of potential buyers of a product seeking a discount on the product. In this instance, phoning the system 600 to indicate a desire to a purchase of the product results in a list of mobile phone identifications being compiled in the database 606 representing potential purchasers of the product. The amount of discount on the product in this instance is proportional to the number of telephone identifications compiled. The equivalent of a digital coupon is sent to each of the mobile phones by text message in accordance with the steps described above with regard to the system 600 such that the coupon is arranged to be displayed on the mobile phone. A subsequent auxiliary text message indicating a further discount may be provided to all of the mobile phones each time another prescribed threshold of potential buyers is reached on the compiled list of mobile phone identifications on the database 606 in association with the discount promotion. Accordingly the size of the discount of the coupon can be set according to a number of mobile phones which have placed phone calls to the advertising phone number of the communications server which is associated with the discount or coupon promotion.

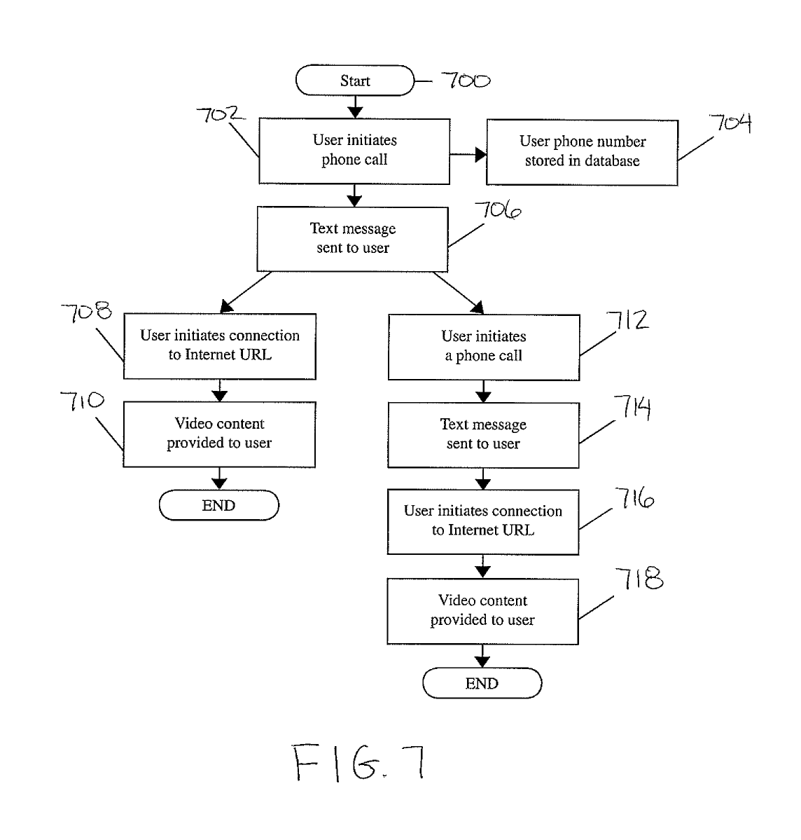

Turning now to FIG. 7, a further example of the system 600 is illustrated in which the system is used for sending media files to the users wherein the media files are consistent with the format of files shown in FIG. 1 and described above in the previous embodiments. The process of FIG. 7 starts by initially providing users with an advertising phone number 700 so that the mobile phone users can initiate a phone call 702 to the system. As described above with regard to the system 600, the identification of the phone number is stored in the database 606 at step 704 in FIG. 7. Also described above with regard to the system 600, at step 706 of FIG. 7 the user which initiated the phone call is sent a text message from the communication server 604. The text message in this instance may comprise an Internet link 708 which the user can follow using their internet connected mobile phone for directly downloading a media file at step 710. Alternatively, the text message may direct the user to a plurality of different selections prompting the user of the mobile phone 602 to take a further action in the form of a text message or a phone call placed back to the system 600 at step 712. In response to the additional phone call to a different advertising phone number, a further text message is sent to the user at step 714 and the additional advertising phone number to which a call was place by the mobile phone is then further associated with the identification of that mobile phone in the database 606. The text message sent to the user at step 714 may further comprise an internet link which allows the user to initiate connection to the internet at step 716 so that the media file can again be downloaded and displayed on the mobile phone of the user at step 718.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of combining advertisements with digital audio content, the method comprising:
receiving a user selection of the audio content;
selecting at least one advertisement from an advertisement database comprising a plurality of advertisements in which each advertisement comprises at least one image; and
creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

2. The method according to claim 1 wherein the user selection comprises an audio file which only comprises the audio content.

3. The method according to claim 1 wherein the user selection comprises a file with audio content and wherein the method includes creating the media file such that the media file comprises only the audio content from the user selected file.

4. The method according to claim 1 including creating the media file after receiving the user selection.

5. The method according to claim 1 including selecting said at least one advertisement according to criteria including a type of the media enabled device.

6. The method according to claim 1 including selecting said at least one advertisement according to criteria including a location of a user.

7. The method according to claim 6 including determining the location of the user according to a positioning technology, a unique network identifier, or a user specification.

8. The method according to claim 1 including selecting said at least one advertisement according to criteria including age of a user.

9. The method according to claim 1 including selecting said at least one advertisement according to criteria including gender of a user.

10. The method according to claim 1 including associating user information with the user selection and selecting said at least one advertisement according to criteria including the user information.

11. The method according to claim 1 including selecting at least one advertisement comprising a plurality of images in a video format and reducing a frame rate of the video format prior to creating the media file comprising said plurality of images in the video format.

12. The method according to claim 1 including incorporating unique indicia into at least one image of the media file being created.

13. The method according to claim 12 in combination with a plurality of promotional codes of a promotion wherein the method includes incorporating the unique indicia into at least one image of the media file being created such that the unique indicia represents a respective one of the promotional codes of the promotion.

14. The method according to claim 1 including incorporating a unique tracking code into the media file being created.

15. The method according to claim 1 wherein each advertisement includes a display duration associated therewith, the method including selecting a plurality of advertisements such that a combined duration of the display durations is equal to or less than a duration of the user selected audio content.

16. The method according to claim 1 including populating the advertisement database with the plurality of advertisements by accepting advertising bids from advertisers, each advertising bid including a payment offer for each instance the advertisement is incorporated into a media file.

17. The method according to claim 16 wherein the payment offer includes a maximum total amount of instances the advertisement is to be incorporated into media files.

18. The method according to claim 16 including creating a media file comprising a plurality of selected advertisements and ordering the plurality of selected advertisements according to an amount of the respective payment offers.

19. The method according to claim 1 including populating the advertisement database with the plurality of advertisements by accepting advertising bids from advertisers, each advertising bid including selection criteria arranged to determine which user selected audio content the advertisement is associated with in creating media files.

20. The method according to claim 1 including populating the advertisement database with the plurality of advertisements by accepting advertising bids from advertisers in which each advertising bid includes a display duration of the advertisement, and selecting a plurality of advertisements such that a combined duration of the display durations is equal to or less than a duration of the user selected audio content.

21. The method according to claim 1 including selecting a unique combination of a plurality of advertisements incorporated into the media file according to user criteria, creating a digital checksum signature of the media file using the unique combination, and storing the digital checksum with a media file creation time and date in a database containing the user criteria when the media file is created.

22. The method according to claim 1 including creating the media file for playback on a media enabled device containing an application and embedding a trigger in the media file which is arranged to be automatically detected by said application responsive to the media file being played on the media enabled device, the trigger being further arranged to execute an auxiliary function in said application.

23. The method according to claim 22 including embedding the media file with a trigger which is arranged to prompt a user for an interaction with the media enabled device prior to executing the auxiliary function in said application.

24. The method according to claim 22 including embedding the media file with a trigger which is arranged to automatically execute the auxiliary function in said application responsive to the detection of the trigger by said application.

25. A method of combining advertisements with audio content suitable for playback on a media enabled device, the method comprising:
receiving a user selection of the audio content;
selecting at least one advertisement from an advertisement database comprising a plurality of advertisements in which each advertisement comprises at least one image; and
incorporating unique indicia into said at least one image of the said at least one advertisement selected;
creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

26. A method of combining advertisements with audio content suitable for playback on a media enabled device, the method comprising:
receiving a user selection of the audio content;
populating an advertisement database with a plurality of advertisements in which each advertisement comprises at least one image by accepting advertising bids from advertisers, each advertising bid including a payment offer for each instance the advertisement is incorporated into a media file;
selecting at least one advertisement from the advertisement database; and
creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device.

27. A method of combining advertisements with audio content suitable for playback on a media enabled device, the method comprising:
receiving a user selection of the audio content;
selecting a unique combination of a plurality of advertisements according to user criteria from an advertisement database comprising a plurality of advertisements in which each advertisement comprises at least one image;
creating a media file arranged for playback on a media enabled device such that:
the media file comprises the user selected audio content and said at least one image of said at least one advertisement selected from the advertisement database; and
said at least one image of said at least one advertisement of the media file is arranged to be displayed in parallel with the audio content when the media file is played on the media enabled device;
creating a digital checksum signature of the media file using the unique combination, and
storing the digital checksum with a media file creation time and date in a database containing the user criteria when the media file is created.

28.-56. (canceled)
